(19) United States
(12) Patent Application Publication
(10) Pub. No.: US 2019/0335415 A1
(43) Pub. Date: Oct. 31, 2019

(54) METHOD, APPARATUS, AND DEVICE FOR SWITCHING GNSS REFERENCE STATION AND STORAGE MEDIUM

(71) Applicant: BAIDU ONLINE NETWORK TECHNOLOGY (BEIJING) CO., LTD., Beijing (CN)

(72) Inventors: Xiangyu FU, Beijing (CN); Jie HUANG, Beijing (CN); Renlan CAI, Beijing (CN); Shiyu SONG, Sunnyvale, CA (US); Fangfang DONG, Beijing (CN)

(21) Appl. No.: 16/505,794

(22) Filed: Jul. 9, 2019

(30) Foreign Application Priority Data
Jul. 19, 2018 (CN) 201810799483.4

(51) Int. Cl. H04W 64/00; H04W 4/029; H04W 4/44; H04W 4/02

(52) U.S. Cl. CPC H04W 64/003; H04W 4/027; H04W 4/44; H04W 4/029

(57) ABSTRACT

The present disclosure provides a method, an apparatus, and a device for switching GNSS reference station and a storage medium. The method of the present disclosure, by that in the process of moving of a positioning device, the positioning device transmits current position of the positioning device itself information to a base station server in real time, and the base station server determines a base station closest to the positioning device according to the current position information of the positioning device and position information of each base station; and the base station server switches a reference station of the positioning device to the base station closest to the positioning device, ensures that in the process of moving of the positioning device, the reference station of the positioning device is automatically switched according to a real-time position of the positioning device.

### CROSS-REFERENCE TO RELATED APPLICATIONS

This application claims priority to Chinese Patent Application No. 201810799483.4, filed on Jul. 19, 2018, which is hereby incorporated by reference in its entirety.

### TECHNICAL FIELD

The present disclosure relates to the field of communication technology, and more particularly to a method, an apparatus, and a device for switching global navigation satellite system (GNSS) reference station and a storage medium.

### BACKGROUND

Real-Time Kinematic (RTK) difference is the most widely used high-precision satellite navigation and positioning technology currently. RTK positioning technology is also widely used in the field of unmanned driving.

In the RTK positioning technology, a base station with a known precise position is pre-established as a reference station, and the reference station provides base station data to a receiving end through a base station server, and the base station data includes the precise position of the reference station and observation data of the reference station. When using RTK technology to position, the receiving end receives the base station data forwarded by the base station server, acquires observation data of the positioning device itself, performs high-precision joint positioning calculation on itself and the reference station according to the base station data of the reference station and observation data of the positioning device itself, and calculates out its own position coordinate.

However, when the distance between the reference station and the receiving end exceeds 30 KM, the positioning accuracy using the RTK technology is reduced. When the existing RTK technology is applied to the field of unmanned vehicle, since the unmanned vehicle usually travels far beyond 30 KM, the distance between the positioning device on the vehicle as the receiving end and its corresponding reference station is too far during the running of the vehicle, resulting in low positioning accuracy of the positioning device of the unmanned vehicle, which is easy to cause serious traffic accident due to inaccurate positioning of the unmanned vehicle.

### SUMMARY

The present disclosure provides a method, an apparatus, and a device for switching GNSS reference station and a storage medium, which are used to solve the problem that when the existing RTK technology is applied to the field of unmanned vehicle, the distance between the positioning device on the vehicle as the receiving end and its corresponding reference station is too far during the running of the vehicle, resulting in low positioning accuracy of the positioning device of the unmanned vehicle, which is easy to cause serious traffic accident due to inaccurate positioning of the unmanned vehicle.

A first aspect of the present disclosure provides a method for switching GNSS reference station, including:

receiving, by a base station server, current position information of a positioning device transmitted by the positioning device;

determining, by the base station server, a base station closest to the positioning device according to the current position information of the positioning device and position information of each base station; and

switching, by the base station server, a reference station of the positioning device to the base station closest to the positioning device.

A second aspect of the present disclosure provides a method for switching GNSS reference station, including:

acquiring, by a positioning device, current position information; and

transmitting, by the positioning device, the current position information of the positioning device to a base station server, so that the base station server determines a base station closest to the positioning device according to the current position information of the positioning device and position information of each base station and switches a reference station of the positioning device to the base station closest to the positioning device.

A third aspect of the present disclosure provides an apparatus for switching GNSS reference station, including:

a communicating module, configured for a base station server to receive current position information of a positioning device transmitted by the positioning device;

a determining module, configured for a base station server to determine a base station closest to the positioning device according to the current position information of the positioning device and position information of each base station; and

a switching module, configured for a base station server to switch a reference station of the positioning device to the base station closest to the positioning device.

A fourth aspect of the present disclosure provides an apparatus for switching GNSS reference station, including:

an acquiring module, configured for a positioning device to acquire current position information; and

a communicating module, configured for the positioning device to transmit the current position information of the positioning device to a base station server, so that the base station server determines a base station closest to the positioning device according to the current position information of the positioning device and position information of each base station and switches a reference station of the positioning device to the base station closest to the positioning device.

A fifth aspect of the present disclosure provides a base station server, including:

a memory, a processor, and a computer program stored in the memory and executable by the processor, the processor implements the method according to the first aspect described above when running the computer program.

A sixth aspect of the present disclosure provides a positioning device, including:

a memory, a processor, and a computer program stored in the memory and executable by the processor, the processor implements the method according to the second aspect described above when running the computer program.

A seventh aspect of the present disclosure provides a computer readable storage medium, including a computer program stored therein,

the computer program implements the method according to the first aspect described above when executed by a processor.

An eighth aspect of the present disclosure provides a computer readable storage medium, including a computer program stored therein,

the computer program implements the method according to the second aspect described above when executed by a processor.

The method, the apparatus, and the device for switching GNSS reference station and the storage medium provided by the present disclosure, by that in the process of moving of a positioning device, the positioning device transmits current position information of the positioning device itself to a base station server in real time, and the base station server determines a base station closest to the positioning device according to the current position information of the positioning device and position information of each base station; and the base station server switches a reference station of the positioning device to the base station closest to the positioning device, ensures that in the process of moving of the positioning device, the reference station of the positioning device is automatically switched according to a real-time position of the positioning device, so that the reference station of the positioning device is the base station closest to the positioning device, which can significantly improve the RTK positioning accuracy of the positioning device, thereby improving the safety of the driving process of unmanned vehicle using RTK positioning.

### BRIEF DESCRIPTION OF THE DRAWINGS

FIG. 1 is a flowchart of a method for switching GNSS reference station provided by the first embodiment of the present disclosure;

FIG. 2 is a schematic diagram of a reference station switching provided by the first embodiment of the present disclosure;

FIG. 3 is a flowchart of a method for switching GNSS reference station provided by the second embodiment of the present disclosure;

FIG. 4 is a flowchart of a method for switching GNSS reference station provided by the third embodiment of the present disclosure;

FIG. 5 is a flowchart of a method for switching GNSS reference station provided by the fourth embodiment of the present disclosure;

FIG. 6 is a schematic structural diagram of an apparatus for switching GNSS reference station provided by the fifth embodiment of the present disclosure;

FIG. 7 is a schematic structural diagram of an apparatus for switching GNSS reference station provided by the sixth embodiment of the present disclosure;

FIG. 8 is a schematic structural diagram of an apparatus for switching GNSS reference station provided by the seventh embodiment of the present disclosure;

FIG. 9 is a schematic structural diagram of a base station server provided by the ninth embodiment of the present disclosure;

FIG. 10 is a schematic structural diagram of a positioning device provided by the tenth embodiment of the present disclosure.

Through the above drawings, embodiments of the present disclosure have been shown clearly, which will be described in more detail later. The drawings and the written description are not intended to limit the scope of the concept of the present disclosure in any way, but to describe the concept of the present disclosure for those skilled in the art by referring to the specific embodiments.

### DETAILED DESCRIPTION OF THE EMBODIMENTS

Exemplary embodiments will be described in detail herein, examples of which are illustrated in the accompanying drawings. Unless otherwise indicated, when the following description involves the accompanying drawings, the same number in different figures refers to a same or similar elements. The implementations described in the following exemplary embodiments do not represent all embodiments consistent with the present disclosure. Instead, they are merely examples of apparatus and methods as detailed in the appended claims and consistent with some aspects of the present disclosure.

First of all, the terminology involved in the present disclosure are explained:

Global Navigation Satellite System (GNSS) positioning is achieved by using observations of a set of satellites such as pseudo-ranges, ephemeris, and satellite launch time and it is also necessary to know the user clock. The GNSS is a space-based radio navigation and positioning system that provides users with all-weather three-dimensional coordinates, speed and time information at any position on the Earth's surface or in near-Earth space.

In addition, the terms “first”, “second”, and the like are only used for the purpose of description, and are not to be understood as indicating or implying a relative importance or implicitly indicating the number of technical features indicated. In the following description of each embodiment, the “multiple” means two or more unless specifically defined otherwise.

The following specific embodiments may be combined with each other, and the same or similar concepts or processes may not be described in some embodiments. Embodiments of the present disclosure will be described below with reference to the accompanying drawings.

### Embodiment 1

FIG. 1 is a flowchart of a method for switching GNSS reference station provided by the first embodiment of the present disclosure. The embodiment of the present disclosure provides a method for switching GNSS reference station for the problem that when the existing RTK technology is applied to the field of unmanned vehicle, the distance between the positioning device on the vehicle as the receiving end and the corresponding reference station is too far during the running of the vehicle, resulting in low positioning accuracy of the positioning device of the unmanned vehicle, which is easy to cause serious traffic accident due to inaccurate positioning of the unmanned vehicle. The method in the embodiment is applied to a base station server in an RTK based positioning system, and the base station server may be a control center server of the RTK based positioning system, or may be a computer device separately established for maintaining the correspondence between each receiving end and the reference station. In other embodiments, the method is also applicable to other devices. The embodiment takes a base station server as an example for illustration. As shown in FIG. 1, the specific steps of the method are as follows:

Step S101: a base station server receives current position information of a positioning device transmitted by the positioning device.

In the embodiment, the positioning device is used as a data receiving end in the RTK positioning system, and the positioning device may be a device disposed on a mobile platform for performing RTK positioning. For example, the positioning device may be a device on an unmanned vehicle for performing RTK positioning. The positioning device may be in a static state or in a moving state; the positioning device may be initialized at a fixed point before entering a dynamic work, or may be directly turned on under a dynamic condition, and may complete searching and solving of an integer ambiguity under a dynamic environment.

Optionally, the current position information of the positioning device may be a current position of the positioning device that is positioned in real time through a GPS. Specifically, the positioning device itself may have a global positioning system (GPS) positioning function, and may position its own position in real time; or, the mobile platform on which the positioning device is located is provided with a GPS positioning device, and the position positioned by the GPS positioning device in real time may be used as the position of the positioning device, and the positioning device may acquire the current position positioned by the GPS positioning device on the mobile platform in real time as the current position of the positioning device. In addition, the positioning device may also acquire the current position of the positioning device positioned in real time through the GPS in other manners, which is not specifically limited herein.

In the embodiment, after the positioning device acquires the current position information of the positioning device itself, the positioning device transmits the current position information of the positioning device itself to the base station server. The base station server may receive the current position information of the positioning device transmitted by the positioning device.

The position of the positioning device on the mobile platform changes in real time during the moving of the mobile platform, and the base station server may receive the real-time position information of the positioning device.

Step S102: the base station server determines a base station closest to the positioning device according to the current position information of the positioning device and position information of each base station.

Since the positioning accuracy of the GPS is lower than that of the RTK positioning, the current position information of the positioning device positioned by the GPS is a rougher position of the positioning device.

After receiving the current position information of the positioning device, the base station server may calculate a distance between the current position of the positioning device and each base station according to the current position information of the positioning device and the position information of each base station, and further determine the base station closest to the positioning device.

Where, the position information of each base station may be a precise position known by the base station. The position information of each base station may be pre-stored on the base station server; or, each base station pre-stores its own position information, and the base station server may acquire the position information of the base station from each base station.

Step S103: the base station server switches a reference station of the positioning device to the base station closest to the positioning device.

After determining the base station closest to the positioning device, the base station server switches the reference station of the positioning device to the base station closest to the positioning device, so that the reference station of the positioning device is the base station currently closest to the positioning device.

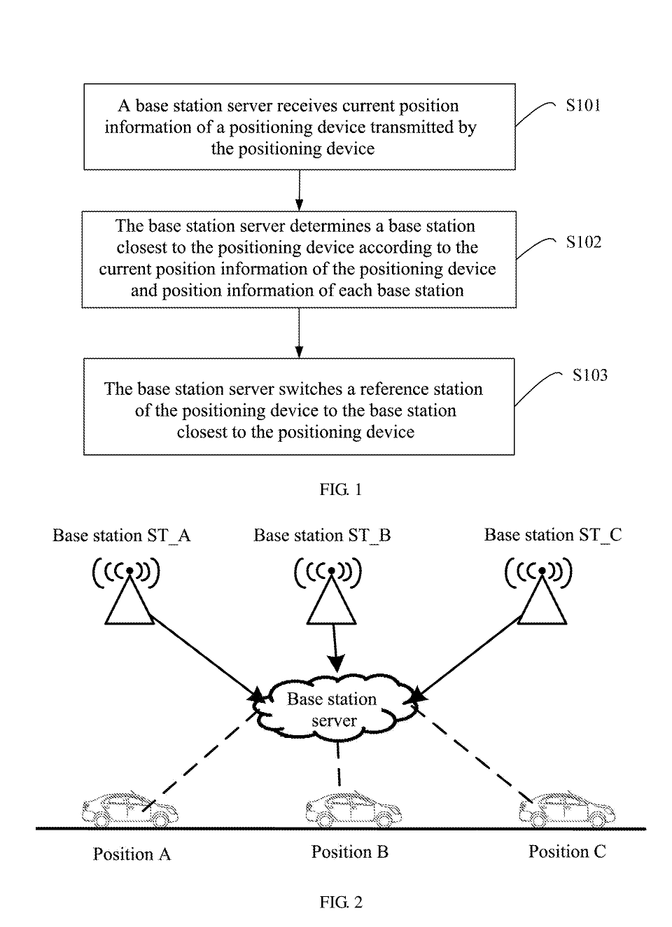

FIG. 2 is a schematic diagram of a reference station switching provided by the first embodiment of the present disclosure. FIG. 2 takes that the positioning device is disposed on the vehicle as an example for illustration. The arrows and dashed lines in the figure are only used to describe that the positioning device disposed on the vehicle and the base station may communicate with the base station server, and a way that the positioning device communicates with the base station may be the same with or different from a way that the positioning device communicates with the base station server. As shown in FIG. 2, during the running of the vehicle, the position of the positioning device on the vehicle changes in real time, and the base station server may receive the real-time position information of the positioning device. When the vehicle travels to the position A, the base station server may know the position A of the positioning device, and may determine that the base station closest to the position A is the base station ST_A by calculation, and at this time, the reference station of the positioning device is switched to the base station ST_A, and the positioning device may perform RTK positioning according to the base station data of the base station ST_A. When the vehicle travels to the position B, the base station server may know the position B of the positioning device, and may determine that the base station closest to the position B is the base station ST_B by calculation, and at this time, the reference station of the positioning device is switched to the base station ST_B, and the positioning device may perform RTK positioning according to the base station data of the base station ST_B. Similarly, when the vehicle travels to the position C, the base station server may know the position C of the positioning device, and may determine that the base station closest to the position C is the base station ST_C by calculation, and at this time, the reference station of the positioning device is switched to the base station ST_C, and the positioning device may perform RTK positioning according to the base station data of the base station ST_C.

After the base station server determines the base station closest to the positioning device, according to the current reference station of the positioning device, the base station server may switch the reference station of the positioning device to the base station closest to the positioning device if the current base station is not the base station closest to the positioning device determined by the base station server; and there is no need to switch the reference station of the positioning device if the current base station is the base station closest to the positioning device determined by the base station server.

The embodiment of the present disclosure, by that in the process of moving of a positioning device, the positioning device transmits current position of the positioning device itself information to a base station server in real time, and the base station server determines a base station closest to the positioning device according to the current position information of the positioning device and position information of each base station; and the base station server switches a reference station of the positioning device to the base station closest to the positioning device, ensures that in the process of moving of the positioning device, the reference station of the positioning device is automatically switched according to a real-time position of the positioning device, so that the reference station of the positioning device is the base station closest to the positioning device, which can significantly improve the RTK positioning accuracy of the positioning device, thereby improving the safety of the driving process of unmanned vehicle using RTK positioning.

### Embodiment 2

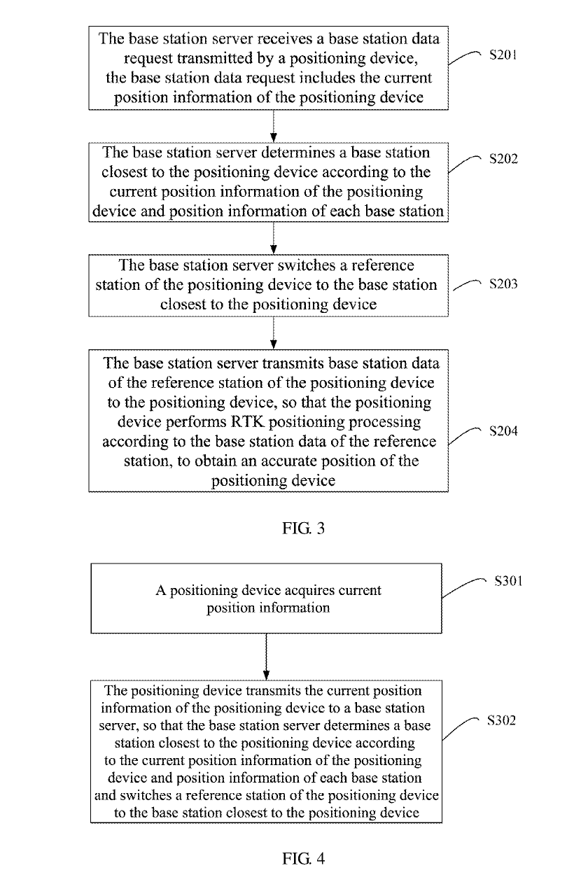

FIG. 3 is a flowchart of a method for switching GNSS reference station provided by the second embodiment of the present disclosure. On the basis of the foregoing first embodiment, in the embodiment, the base station server receives the current position information of the positioning device transmitted by the positioning device, includes: the base station server receives a base station data request transmitted by the positioning device, the base station data request includes the current position information of the positioning device. As shown in FIG. 3, the specific steps of the method are as follows:

Step S201: the base station server receives a base station data request transmitted by a positioning device, the base station data request includes the current position information of the positioning device.

Where the current position information of the positioning device is a current position that the positioning device positions in real time through a GPS.

The positioning device is used as a data receiving end in the RTK positioning system, and the positioning device may be a device disposed on the mobile platform for performing RTK positioning. For example, the positioning device may be a device on an unmanned vehicle for performing RTK positioning. The positioning device may be in a static state or in a moving state; and the positioning device may be initialized at a fixed point before entering a dynamic work, or may be directly turned on under a dynamic condition, and may complete searching and solving of an integer ambiguity under a dynamic environment.

Optionally, the current position information of the positioning device may be a current position of the positioning device that is positioned in real time through a GPS. Specifically, the positioning device itself may have a GPS positioning function, and may position its own position in real time; or, the mobile platform on which the positioning device is located is provided with a GPS positioning device, and the position positioned by the GPS positioning device in real time may be used as the position of the positioning device, and the positioning device may acquire the current position positioned by the GPS positioning device on the mobile platform in real time as the current position of the positioning device. In addition, the positioning device may also acquire the current position of the positioning device positioned in real time through the GPS in other manners, which is not specifically limited herein.

In the embodiment, the positioning device may transmit a base station data request to the base station server when RTK positioning is needed, the base station data request includes the current position information of the positioning device.

Step S202: the base station server determines a base station closest to the positioning device according to the current position information of the positioning device and position information of each base station.

Since the positioning accuracy of the GPS is lower than that of the RTK positioning, the current position information of the positioning device positioned by the GPS is a rougher position of the positioning device.

After receiving the current position information of the positioning device, the base station server may calculate the distance between the current position of the positioning device and each base station according to the current position information of the positioning device and the position information of each base station, and further determine the base station closest to the positioning device.

Where, the position information of each base station may be a precise position known by the base station.

Optionally, the position information of each base station may be pre-stored on the base station server. Before the base station server determines the base station closest to the positioning device according to the current position information and the position information of each base station, the base station server may read the position information of each base station locally.

Optionally, each base station pre-stores its own position information, and the base station server may acquire the position information of the base station from each base station.

Specifically, before the base station server determines the base station closest to the positioning device according to the current position information and the position information of each base station, the base station server receives base station data transmitted by each base station, parses the position information of each base station from the base station data transmitted by each base station, and stores the acquired position information of each base station.

Step S203: the base station server switches a reference station of the positioning device to the base station closest to the positioning device.

This step is the same as the above step S103, and details are not described herein again.

Step S204: the base station server transmits base station data of the reference station of the positioning device to the positioning device, so that the positioning device performs RTK positioning processing according to the base station data of the reference station, to obtain an accurate position of the positioning device.

Where the base station data includes the precise position of the reference station of the reference station and observation data of the reference station.

After the base station server switches the reference station of the positioning device to the base station closest to the positioning device, the base station server transmits base station data of the reference station of the positioning device to the positioning device. The positioning device performs RTK positioning processing according to the base station data of the reference station and observation data of the positioning device itself, to obtain an accurate position of the positioning device.

The embodiment of the present disclosure, by that in the process of moving of a positioning device, the positioning device transmits current position of the positioning device itself information to a base station server in real time, and the base station server determines a base station closest to the positioning device according to the current position information of the positioning device and position information of each base station; and the base station server switches a reference station of the positioning device to the base station closest to the positioning device, ensures that in the process of moving of the positioning device, the reference station of the positioning device is automatically switched according to a real-time position of the positioning device, so that the reference station of the positioning device is the base station closest to the positioning device, which can significantly improve the RTK positioning accuracy of the positioning device, thereby improving the safety of the driving process of unmanned vehicle using RTK positioning.

### Embodiment 3

FIG. 4 is a flowchart of a method for switching GNSS reference station provided by a third embodiment of the present disclosure. The embodiment of the present disclosure provides a method for switching GNSS reference station for the problem that when the existing RTK technology is applied to the field of unmanned vehicle, the distance between the positioning device on the vehicle as the receiving end and its corresponding reference station is too far during the running of the vehicle, resulting in low positioning accuracy of the positioning device of the unmanned vehicle, which is easy to cause serious traffic accident due to inaccurate positioning of the unmanned vehicle. The method in the embodiment is applied to a data receiving end in an RTK positioning system, and the data receiving end may be a positioning device disposed on the mobile platform and the like. In other embodiments, the method is also applicable to other devices. The embodiment takes a positioning device disposed on the mobile platform as an example for illustration. As shown in FIG. 4, the specific steps of the method are as follows:

Step S301: a positioning device acquires current position information.

In the embodiment, the positioning device is used as a data receiving end in the RTK positioning system, and the positioning device may be a device disposed on the mobile platform for performing RTK positioning. For example, the positioning device may be a device on an unmanned vehicle for performing RTK positioning. The positioning device may be in a static state or in a moving state; the positioning device may be initialized at a fixed point before entering a dynamic work, or may be directly turned on under a dynamic condition, and complete searching and solving of an integer ambiguity under a dynamic environment.

Optionally, the positioning device may position the current position of the positioning device itself in real time through a GPS. Specifically, the positioning device itself may have a GPS positioning function, and may position its own position in real time; or, the mobile platform on which the positioning device is located is provided with a GPS positioning device, and the position positioned by the GPS positioning device in real time may be used as the position of the positioning device, and the positioning device may acquire the current position positioned by the GPS positioning device on the mobile platform in real time as the current position of the positioning device. In addition, the positioning device may also acquire the current position of the positioning device positioned in real time through the GPS in other manners, which is not specifically limited herein.

Step S302: the positioning device transmits the current position information of the positioning device to a base station server, so that the base station server determines a base station closest to the positioning device according to the current position information of the positioning device and position information of each base station and switches a reference station of the positioning device to the base station closest to the positioning device.

In the embodiment, after the positioning device acquires the current position of the positioning device itself information, the positioning device transmits the current position of the positioning device itself information to the base station server. The base station server may receive the current position information of the positioning device transmitted by the positioning device.

The position of the positioning device on the mobile platform changes in real time during the moving of the mobile platform, and the base station server may receive the real-time position information of the positioning device.

Since the positioning accuracy of the GPS is lower than that of the RTK positioning, the current position information of the positioning device positioned by the GPS is a rougher position of the positioning device.

After receiving the current position information of the positioning device, the base station server may calculate the distance between the current position of the positioning device and each base station according to the current position information of the positioning device and the position information of each base station, and further determine the base station closest to the positioning device. After determining the base station closest to the positioning device, the base station server switches the reference station of the positioning device to the base station closest to the positioning device, so that the reference station of the positioning device is the base station currently closest to the positioning device.

The embodiment of the present disclosure, by that in the process of moving of a positioning device, the positioning device transmits current position of the positioning device itself information to a base station server in real time, and the base station server determines a base station closest to the positioning device according to the current position information of the positioning device and position information of each base station; and the base station server switches a reference station of the positioning device to the base station closest to the positioning device, ensures that in the process of moving of the positioning device, the reference station of the positioning device is automatically switched according to a real-time position of the positioning device, so that the reference station of the positioning device is the base station closest to the positioning device, which can significantly improve the RTK positioning accuracy of the positioning device, thereby improving the safety of the driving process of unmanned vehicle using RTK positioning.

### Embodiment 4

FIG. 5 is a flowchart of a method for switching GNSS reference station provided by a fourth embodiment of the present disclosure. On the basis of the foregoing third embodiment, in the embodiment, the positioning device transmits the current position information of the positioning device to the base station server, includes: the positioning device transmits a base station data request to the base station server, the base station data request includes the current position information of the positioning device. As shown in FIG. 5, the specific steps of the method are as follows:

Step S401: a positioning device acquires current position information.

This step is the same as the above step S301, and details are not described herein again.

Step S402: the positioning device transmits a base station data request to the base station server, the base station data request includes the current position information of the positioning device, so that the base station server determines a base station closest to the positioning device according to the current position information of the positioning device and position information of each base station and switches a reference station of the positioning device to the base station closest to the positioning device.

Where, the current position information of the positioning device a current position that the positioning device positions in real time through a GPS.

The positioning device is used as a data receiving end in the RTK positioning system, and the positioning device may be a device disposed on the mobile platform for performing RTK positioning. For example, the positioning device may be a device on an unmanned vehicle for performing RTK positioning. The positioning device may be in a static state or in a moving state; the positioning device may be initialized at a fixed point before entering a dynamic work, or may be directly turned on under a dynamic condition, and complete searching and solving of an integer ambiguity under a dynamic environment.

Optionally, the current position information of the positioning device may be a current position of the positioning device that is positioned in real time through a GPS. Specifically, the positioning device itself may have a GPS positioning function, and may position its own position in real time; or, the mobile platform on which the positioning device is located is provided with a GPS positioning device, and the position positioned by the GPS positioning device in real time may be used as the position of the positioning device, and the positioning device may acquire the current position positioned by the GPS positioning device on the mobile platform in real time as the current position of the positioning device. In addition, the positioning device may also acquire the current position of the positioning device positioned in real time through the GPS in other manners, which is not specifically limited herein.

In the embodiment, the positioning device may transmit a base station data request to the base station server when RTK positioning is needed, the base station data request includes the current position information of the positioning device.

The base station server determines a base station closest to the positioning device according to the current position information of the positioning device and position information of each base station and switches a reference station of the positioning device to the base station closest to the positioning device.

After the base station server switches the reference station of the positioning device to the base station closest to the positioning device, the base station server transmits base station data of the reference station of the positioning device to the positioning device. Where the base station data includes the precise position of the reference station and observation data of the reference station.

Step S403: the positioning device receives base station data of the reference station of the positioning device transmitted by the base station server.

Step S404: the positioning device performs RTK positioning processing according to the base station data of the reference station and observation data of the positioning device itself, to obtain an accurate position of the positioning device.

In the embodiment, the positioning device performs RTK positioning processing according to the base station data of the reference station and observation data of the positioning device itself, to obtain an accurate position of the positioning device, may implement using any method in the prior art for performing RTK positioning according to the base station data of the reference station and observation data of the positioning device itself, which is not described herein again.

The embodiment of the present disclosure, by that in the process of moving of a positioning device, the positioning device transmits current position of the positioning device itself information to a base station server in real time, and the base station server determines a base station closest to the positioning device according to the current position information of the positioning device and position information of each base station; and the base station server switches a reference station of the positioning device to the base station closest to the positioning device, ensures that in the process of moving of the positioning device, the reference station of the positioning device is automatically switched according to a real-time position of the positioning device, so that the reference station of the positioning device is the base station closest to the positioning device, which can significantly improve the RTK positioning accuracy of the positioning device, thereby improving the safety of the driving process of unmanned vehicle using RTK positioning.

### Embodiment 5

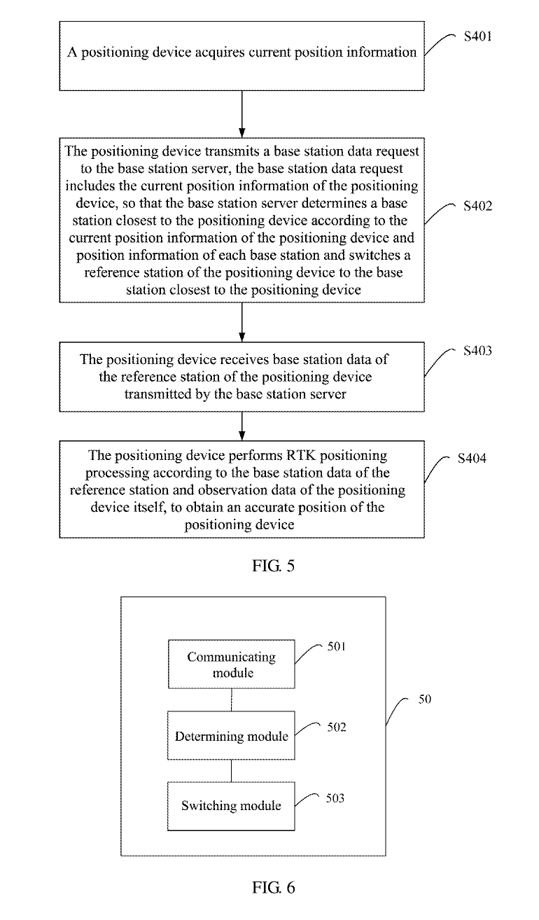

FIG. 6 is a schematic structural diagram of an apparatus for switching GNSS reference station provided by a fifth embodiment of the present disclosure. The apparatus for switching GNSS reference station provided by the embodiment of the present disclosure may perform the processing flow provided by the embodiment of the method for switching GNSS reference station. As shown in FIG. 6, the apparatus 50 includes: a communicating module 501, a determining module 502, and a switching module 503.

Specifically, the communicating module 501 is configured for a base station server to receive current position information of a positioning device transmitted by the positioning device.

The determining module 502 is configured for the base station server to determine a base station closest to the positioning device according to the current position information of the positioning device and position information of each base station.

The switching module 503 is configured for the base station server to switch a reference station of the positioning device to the base station closest to the positioning device.

The apparatus provided by the embodiment of the present disclosure may be specifically used to perform the method embodiment provided in the foregoing first embodiment, and the specific functions are not described herein again.

The embodiment of the present disclosure, by that in the process of moving of a positioning device, the positioning device transmits current position of the positioning device itself information to a base station server in real time, and the base station server determines a base station closest to the positioning device according to the current position information of the positioning device and position information of each base station; and the base station server switches a reference station of the positioning device to the base station closest to the positioning device, ensures that in the process of moving of the positioning device, the reference station of the positioning device is automatically switched according to a real-time position of the positioning device, so that the reference station of the positioning device is the base station closest to the positioning device, which can significantly improve the RTK positioning accuracy of the positioning device, thereby improving the safety of the driving process of unmanned vehicle using RTK positioning.

### Embodiment 6

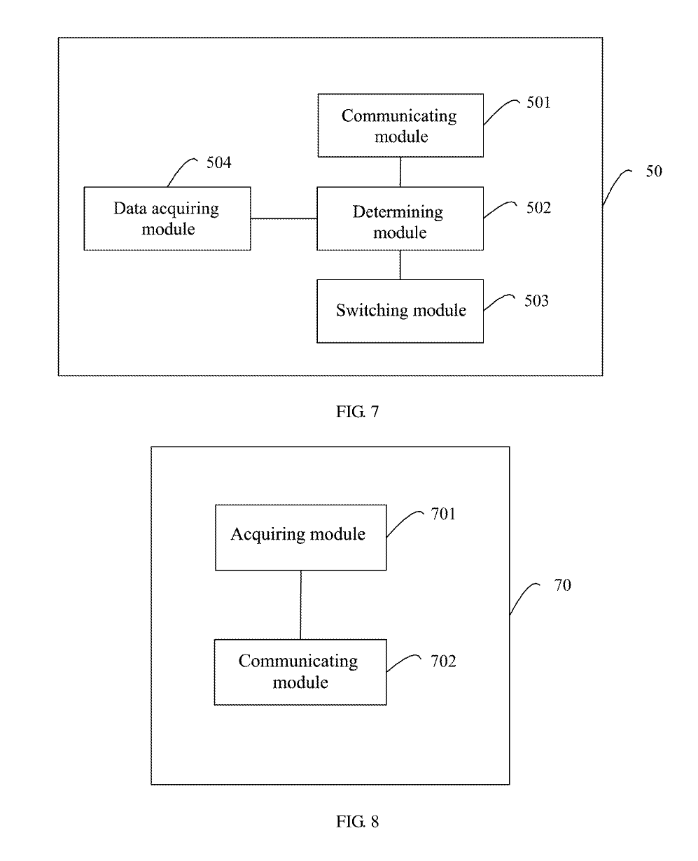

FIG. 7 is a schematic structural diagram of an apparatus for switching GNSS reference station provided by a sixth embodiment of the present disclosure. On the basis of the foregoing fifth embodiment, in the embodiment, the communicating module 501 is further configured for the base station server to receive a base station data request transmitted by the positioning device, the base station data request includes the current position information of the positioning device.

Optionally, the current position information of the positioning device is a current position that the positioning device positions in real time through a GPS.

Optionally, the communicating module 501 is further configured for the base station server to transmit base station data of the reference station of the positioning device to the positioning device, so that the positioning device performs RTK positioning processing according to the base station data of the reference station, to obtain an accurate position of the positioning device.

Optionally, as shown in FIG. 7, the apparatus 50 further includes a data acquiring module 504.

The data acquiring module 504 is configured for the base station server to:

receive base station data transmitted by each base station; parse the position information of each base station from the base station data transmitted by each base station; and store the acquired position information of each base station.

The apparatus provided by the embodiment of the present disclosure may be specifically used to perform the method embodiment provided in the foregoing second embodiment, and the specific functions are not described herein again.

The embodiment of the present disclosure, by that in the process of moving of a positioning device, the positioning device transmits current position of the positioning device itself information to a base station server in real time, and the base station server determines a base station closest to the positioning device according to the current position information of the positioning device and position information of each base station; and the base station server switches a reference station of the positioning device to the base station closest to the positioning device, ensures that in the process of moving of the positioning device, the reference station of the positioning device is automatically switched according to a real-time position of the positioning device, so that the reference station of the positioning device is the base station closest to the positioning device, which can significantly improve the RTK positioning accuracy of the positioning device, thereby improving the safety of the driving process of unmanned vehicle using RTK positioning.

### Embodiment 7

FIG. 8 is a schematic structural diagram of an apparatus for switching GNSS reference station provided by a seventh embodiment of the present disclosure. The apparatus for switching GNSS reference station provided by the embodiment of the present disclosure may perform the processing flow provided by the embodiment of the method for switching GNSS reference station. As shown in FIG. 8, the apparatus 70 includes: an acquiring module 701 and a communicating module 702.

Specifically, the acquiring module 701 is configured for a positioning device to acquire current position information.

The communicating module 702 is configured for a positioning device to transmit the current position information of the positioning device to a base station server, so that the base station server determines a base station closest to the positioning device according to the current position information of the positioning device and position information of each base station and switches a reference station of the positioning device to the base station closest to the positioning device.

The apparatus provided by the embodiment of the present disclosure may be specifically used to perform the method embodiment provided in the foregoing third embodiment, and the specific functions are not described herein again.

The embodiment of the present disclosure, by that in the process of moving of a positioning device, the positioning device transmits current position of the positioning device itself information to a base station server in real time, and the base station server determines a base station closest to the positioning device according to the current position information of the positioning device and position information of each base station; and the base station server switches a reference station of the positioning device to the base station closest to the positioning device, ensures that in the process of moving of the positioning device, the reference station of the positioning device is automatically switched according to a real-time position of the positioning device, so that the reference station of the positioning device is the base station closest to the positioning device, which can significantly improve the RTK positioning accuracy of the positioning device, thereby improving the safety of the driving process of unmanned vehicle using RTK positioning.

### Embodiment 8

On the basis of the foregoing seventh embodiment, in the embodiment, the acquiring module is further configured for the positioning device to position the current position of the positioning device itself in real time through a GPS.

Optionally, the communicating module is further configured for the positioning device to transmit a base station data request to the base station server, the base station data request includes the current position information of the positioning device.

Optionally, the apparatus further includes a positioning processing module.

The positioning processing module is configured for the positioning device to: receive base station data of the reference station of the positioning device transmitted by the base station server, and perform RTK positioning processing according to the base station data of the reference station and observation data of the positioning device itself, to obtain an accurate position of the positioning device.

The apparatus provided by the embodiment of the present disclosure may be specifically used to perform the method embodiment provided in the foregoing fourth embodiment, and the specific functions are not described herein again.

The embodiment of the present disclosure, by that in the process of moving of a positioning device, the positioning device transmits current position of the positioning device itself information to a base station server in real time, and the base station server determines a base station closest to the positioning device according to the current position information of the positioning device and position information of each base station; and the base station server switches a reference station of the positioning device to the base station closest to the positioning device, ensures that in the process of moving of the positioning device, the reference station of the positioning device is automatically switched according to a real-time position of the positioning device, so that the reference station of the positioning device is the base station closest to the positioning device, which can significantly improve the RTK positioning accuracy of the positioning device, thereby improving the safety of the driving process of unmanned vehicle using RTK positioning.

### Embodiment 9

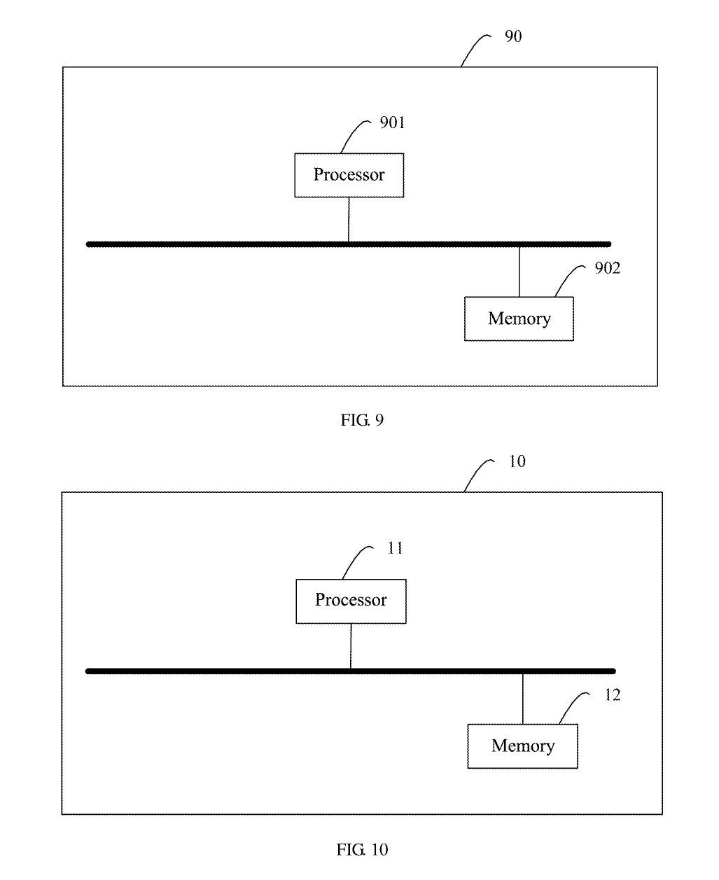

FIG. 9 is a schematic structural diagram of a base station server provided by a ninth embodiment of the present disclosure. As shown in FIG. 9, the base station server 90 includes: a processor 901, a memory 902, and a computer program stored in the memory 902 and executable by the processor 901.

The processor 901 implements the method for switching GNSS reference station provided by the first embodiment or the second embodiment above when executing the computer program stored in the memory 902.

The embodiment of the present disclosure, by that in the process of moving of a positioning device, the positioning device transmits current position of the positioning device itself information to a base station server in real time, and the base station server determines a base station closest to the positioning device according to the current position information of the positioning device and position information of each base station; and the base station server switches a reference station of the positioning device to the base station closest to the positioning device, ensures that in the process of moving of the positioning device, the reference station of the positioning device is automatically switched according to a real-time position of the positioning device, so that the reference station of the positioning device is the base station closest to the positioning device, which can significantly improve the RTK positioning accuracy of the positioning device, thereby improving the safety of the driving process of unmanned vehicle using RTK positioning.

### Embodiment 10

FIG. 10 is a schematic structural diagram of a positioning device provided by a tenth embodiment of the present disclosure. As shown in FIG. 10, the positioning device 10 includes: a memory 11, a processor 12, and a computer program stored in the memory 12 and executable by the processor 11.

The processor 11 implements the method for switching GNSS reference station provided by the third embodiment or the fourth embodiment above when executing the computer program stored in the memory 12.

The embodiment of the present disclosure, by that in the process of moving of a positioning device, the positioning device transmits current position of the positioning device itself information to a base station server in real time, and the base station server determines a base station closest to the positioning device according to the current position information of the positioning device and position information of each base station; and the base station server switches a reference station of the positioning device to the base station closest to the positioning device, ensures that in the process of moving of the positioning device, the reference station of the positioning device is automatically switched according to a real-time position of the positioning device, so that the reference station of the positioning device is the base station closest to the positioning device, which can significantly improve the RTK positioning accuracy of the positioning device, thereby improving the safety of the driving process of unmanned vehicle using RTK positioning.

In addition, the embodiment of the present disclosure further provides a computer readable storage medium, including a computer program stored therein, the computer program implements the method for switching GNSS reference station provided by the first embodiment or the second embodiment above when executed by a processor.

The embodiment of the present disclosure further provides another computer readable storage medium, including a computer program stored therein, the computer program implements the method for switching GNSS reference station provided by the third embodiment or the fourth embodiment above when executed by a processor.

In several embodiments provided by the present disclosure, it should be understood that the disclosed apparatus and method may be implemented in other manners. For example, the apparatus embodiments described above are merely illustrative. For example, the division of the units is only a logical function division. In actual implementation, there may be another division manner, for example, multiple units or components may be combined or may be integrated into another system, or some features can be ignored or not executed. In addition, the mutual coupling or direct coupling or communication connection shown or discussed may be an indirect coupling or communication connection through some interface, apparatus or unit, and may be electrical, mechanical or otherwise.

The units described as separate components may be or may not be physically separated, and the components displayed as units may be or may not be physical units, that is, may be located in a same place, or may be distributed to multiple network units. Some or all of the units may be selected according to actual needs to achieve the purpose of the solution of the embodiment.

In addition, each functional unit in each embodiment of the present disclosure may be integrated into one processing unit, or each unit may exist physically separately, or two or more units may be integrated into one unit. The above integrated unit may be implemented in a form of hardware, in a form of a software functional unit, or in a form of hardware plus software functional units.

The above-described integrated unit implemented in the form of a software functional unit may be stored in a computer readable storage medium. The above software functional unit is stored in a storage medium and includes several instructions configured to be executed by a computer device (which may be a personal computer, a server, or a network device and the like) or a processor to perform part of the steps of the method according to each embodiment of the present disclosure. The foregoing storage medium includes: a U disk, a mobile hard disk, a read-only memory (ROM), a random access memory (RAM), a magnetic disk, or an optical disk, and the like, which may store program codes.

Those skilled in the art can clearly understand that for the convenience and brevity of the description, only the division of each functional module described above is exemplified. In practical applications, the above function assignment may be completed by different functional modules as needed, that is, the internal structure of the apparatus is divided into different functional modules to perform all or part of the functions described above. For the specific working process of the apparatus described above, reference may be made to the corresponding process in the foregoing method embodiments, and details are not described herein again.

Other implementations of the present disclosure will be apparent to those skilled in the art after considering the description and practicing the disclosure disclosed herein. The present disclosure is intended to cover any variation, use, or adaptive modification of the present disclosure, which are in accordance with the general principle of the present disclosure and include common knowledge or common technical means in the art that are not disclosed in the present disclosure. The specification and embodiments are to be regarded as illustrative only, the true scope and spirit of the present disclosure is pointed out by the following claims.

It should be understood that, the present disclosure is not limited to the details of the precise structure described above and shown in accompanying drawings, and various modifications and variations may be made without departing from the scope thereof. The scope of the present disclosure is limited only by the appended claims.

What is claimed is:

1. A method for switching global navigation satellite system (GNSS) reference station, comprising:
receiving, by a base station server, current position information of a positioning device transmitted by the positioning device;
determining, by the base station server, a base station closest to the positioning device according to the current position information of the positioning device and position information of each base station; and
switching, by the base station server, a reference station of the positioning device to the base station closest to the positioning device.

2. The method according to claim 1, wherein, the receiving, by the base station server, the current position information of the positioning device transmitted by the positioning device, comprises:
receiving, by the base station server, a base station data request transmitted by the positioning device, the base station data request comprising the current position information of the positioning device.

3. The method according to claim 1, wherein the current position information of the positioning device is a current position that the positioning device positions in real time through a global positioning system (GPS).

4. The method according to claim 1, after the switching, by the base station server, the reference station of the positioning device to the base station closest to the positioning device, further comprising:
transmitting, by the base station server, base station data of the reference station of the positioning device to the positioning device, so that the positioning device performs real time kinematic (RTK) positioning processing according to the base station data of the reference station, to obtain an accurate position of the positioning device.

5. The method according to claim 1, before the determining, by the base station server, the base station closest to the positioning device according to the current position information of the positioning device and the position information of each base station, further comprising:
receiving, by the base station server, base station data transmitted by each base station;
parsing, by the base station server, the position information of each base station from the base station data transmitted by the each base station; and
storing, by the base station server, the acquired position information of each the base station.

6. A method for switching global navigation satellite system (GNSS) reference station, comprising:
acquiring, by a positioning device, current position information; and
transmitting, by the positioning device, the current position information of the positioning device to a base station server, so that the base station server determines a base station closest to the positioning device according to the current position information of the positioning device and position information of each base station and switches a reference station of the positioning device to the base station closest to the positioning device.

7. The method according to claim 6, wherein, the acquiring, by the positioning device, the current position information, comprises:
positioning, by the positioning device, the current position of the positioning device itself in real time through a global positioning system (GPS).

8. The method according to claim 6, wherein, the transmitting, by the positioning device, the current position information of the positioning device to the base station server, comprises:
transmitting, by the positioning device, a base station data request to the base station server, the base station data request comprising the current position information of the positioning device.

9. The method according to claim 6, after the transmitting, by the positioning device, the current position information of the positioning device to the base station server, so that the base station server determines the base station closest to the positioning device according to the current position information of the positioning device and the position information of each base station and switches the reference station of the positioning device to the base station closest to the positioning device, further comprising:
receiving, by the positioning device, base station data of the reference station of the positioning device transmitted by the base station server; and
performing, by the positioning device, real time kinematic (RTK) positioning processing according to the base station data of the reference station and observation data of the positioning device itself, to obtain an accurate position of the positioning device.

10. An apparatus for switching global navigation satellite system (GNSS) reference station, comprising:
a memory, a processor, and a computer program stored in the memory and executable by the processor,
the processor is configured to execute the computer program to:
receive current position information of a positioning device transmitted by the positioning device;
determine a base station closest to the positioning device according to the current position information of the positioning device and position information of each base station; and
switch a reference station of the positioning device to the base station closest to the positioning device.

11. The apparatus according to claim 10, wherein the processor is configured to execute the computer program to:
receive a base station data request transmitted by the positioning device, the base station data request comprising the current position information of the positioning device.

12. The apparatus according to claim 10, wherein the processor is configured to execute the computer program to:
transmit base station data of the reference station of the positioning device to the positioning device, so that the positioning device performs real time kinematic (RTK) positioning processing according to the base station data of the reference station, to obtain an accurate position of the positioning device.

13. The apparatus according to claim 10, the processor is configured to execute the computer program to:
receive base station data transmitted by each base station; and
parse the position information of each base station from the base station data transmitted by the each base station; and
store the acquired position information of each the base station.

14. An apparatus for switching global navigation satellite system (GNSS) reference station, comprising:
a memory, a processor, and a computer program stored in the memory and executable by the processor,
the processor is configured to execute the computer program to:
acquire current position information; and
transmit the current position information of the positioning device to a base station server, so that the base station server determines a base station closest to the positioning device according to the current position information of the positioning device and position information of each base station and switches a reference station of the positioning device to the base station closest to the positioning device.

15. The apparatus according to claim 14, wherein the processor is configured to execute the computer program to:
position the current position of the positioning device itself in real time through a global positioning system (GPS).

16. The apparatus according to claim 14, wherein the processor is configured to execute the computer program to:
transmit a base station data request to the base station server, the base station data request comprising the current position information of the positioning device.
